(19) United States
(12) Patent Application Publication
(10) Pub. No.: US 2016/0054223 A1
(43) Pub. Date: Feb. 25, 2016

(54) METHOD FOR MEASURING ANALYTE

(71) Applicant: MURATA MANUFACTURING CO., LTD., Nagaokakyo-shi (JP)

(72) Inventors: Seiji KAMBA, Nagaokakyo-shi (JP); Takashi Kondo, Nagaokakyo-shi (JP); Hirokazu Seto, Nagaokakyo-shi (JP); Yoshiko Miura, Nagaokakyo-shi (JP)

(21) Appl. No.: 14/884,132

(22) Filed: Oct. 15, 2015

Related U.S. Application Data
(63) Continuation of application No. PCT/JP2014/058168, filed on Mar. 25, 2014.

(30) Foreign Application Priority Data
May 31, 2013 (JP) 2013-115597

(51) Int. Cl. G01N 21/51

(52) U.S. Cl. CPC G01N 21/51

(57) ABSTRACT

A method for measuring the presence or amount of at least one analyte in a sample mixture that includes capturing a first analyte on a first cavity arrangement structure having a plurality of cavities; capturing an impurity present in the sample mixture or a second analyte on a second cavity arrangement structure that has a plurality of cavities and that differs from the first cavity arrangement structure in at least one of cavity size and surface modification; and after these steps, irradiating the first cavity arrangement structure or the first and second cavity arrangement structures with electromagnetic radiation and detecting the characteristics of scattered electromagnetic radiation.

### CROSS REFERENCE TO RELATED APPLICATIONS

The present application is a continuation of International application No. PCT/JP2014/058168, filed Mar. 25, 2014, which claims priority to Japanese Patent Application No. 2013-115597, filed May 31, 2013, the entire contents of each of which are incorporated herein by reference.

### FIELD OF THE INVENTION

The present invention relates to methods for measuring analytes. More specifically, the invention relates to a method for measuring the presence or amount of an analyte by retaining the analyte on a cavity arrangement structure having cavities, irradiating the cavity arrangement structure with electromagnetic radiation, and detecting the characteristics of the electromagnetic radiation scattered by the cavity arrangement structure.

### BACKGROUND OF THE INVENTION

In the related art, the properties of materials are analyzed using methods for measuring the presence or amount of an analyte by retaining the analyte on a cavity arrangement structure, irradiating the cavity arrangement structure on which the analyte is retained with electromagnetic radiation, and analyzing the characteristics, such as transmission spectrum, of the electromagnetic radiation. Specific examples of such methods include those involving irradiating an analyte, such as a protein, deposited on a metal mesh filter with terahertz radiation and analyzing the transmission spectrum.

One such method for analyzing the transmission spectrum of electromagnetic radiation in the related art is disclosed in Patent Document 1 (Japanese Unexamined Patent Application Publication No. 2008-185552). This document discloses a measuring method involving irradiating a cavity arrangement structure (specifically, a mesh-like conductive plate) having cavity regions in which an analyte is retained with electromagnetic radiation in a direction inclined with respect to the direction perpendicular to the main surfaces of the cavity arrangement structure, measuring the electromagnetic radiation transmitted by the cavity arrangement structure, and detecting the properties of the analyte based on a shift in the position of a dip waveform found in the frequency characteristics of the measurements due to the presence of the analyte.

When such measuring methods are used to measure an analyte present in a sample in the related art, the analyte is typically first extracted from the sample and is then retained on a cavity arrangement structure before electromagnetic radiation measurement. This requires the step of extracting the analyte before the measurement and thus poses a problem in that an additional operating step is needed for the measurement.

For example, when an analyte is extracted from a sample such as a liquid or gas by filtration through a membrane filter, the step of moving the extracted analyte to a cavity arrangement structure by a process such as transfer is needed. Unfortunately, it is difficult to move all extracted analyte to the cavity arrangement structure, and the measurements may show large variations.

Patent Document 1: Japanese Unexamined Patent Application Publication No. 2008-185552

### SUMMARY OF THE INVENTION

In view of the foregoing background, an object of the present invention is to solve problems such as the need for an additional operating step to extract an analyte from a sample and variations in measurements and to provide a method for accurately measuring an analyte present in a sample by a simple process.

The present invention provides a method for measuring the presence or amount of at least one analyte in a sample mixture. This method includes:

a first capturing step of capturing a first analyte present as one analyte on a first cavity arrangement structure having a pair of opposing main surfaces and a plurality of cavities extending through both main surfaces;

a second capturing step of capturing an impurity, other than the analyte, present in the sample or a second analyte different from the first analyte on a second cavity arrangement structure that has a pair of opposing main surfaces and a plurality of cavities extending through both main surfaces and that differs from the first cavity arrangement structure in at least one of cavity size and surface modification; and

after the first and second capturing steps, a measuring step of irradiating the first cavity arrangement structure or the first and second cavity arrangement structures with electromagnetic radiation and detecting the characteristics of electromagnetic radiation scattered by the first cavity arrangement structure or the first and second cavity arrangement structures.

The cavities of the first cavity arrangement structure are preferably sized to allow little or no first analyte to pass through the cavities. The first cavity arrangement structure preferably has a surface modified to adsorb the first analyte.

The first capturing step is preferably performed after the second capturing step.

The cavities of the second cavity arrangement structure are preferably sized to allow little or no impurity or second analyte to pass through the cavities and to allow the first analyte to pass through the cavities. The second cavity arrangement structure preferably has a surface modified to adsorb the impurity or the second analyte and to adsorb little first analyte.

The first and second capturing steps are preferably performed by arranging the first and second cavity arrangement structures in series and allowing the sample to flow through the second cavity arrangement structure and then through the first cavity arrangement structure.

The sample is preferably a liquid or a gas. The analyte is preferably a microorganism or a cell in a liquid, or an inorganic substance, an organic substance, or a hybrid thereof in a gas.

According to the present invention, a cavity arrangement structure can be used both as a capturing device and as a measuring device to allow accurate measurement of an analyte present in a sample by a simple process. Different cavity arrangement structures can also be used to simultaneously measure a plurality of analytes or to selectively measure an analyte present in a sample containing impurities.

### BRIEF DESCRIPTION OF THE DRAWINGS

FIGS. 1(a) and 1(b) are a series of schematic views illustrating a cavity arrangement structure used in the present invention.

FIG. 2 is a schematic view illustrating an example measuring step in the present invention.

FIGS. 3(a) and 3(b) are a series of schematic views illustrating a measuring method according to a first embodiment.

FIGS. 4(a) and 4(b) are a series of schematic views illustrating a measuring method according to a second embodiment.

FIG. 5 is a schematic view illustrating a measuring method used in Example 2.

FIG. 6 is a graph showing measurements obtained in Example 1.

FIG. 7 is a regression curve derived from the measurements obtained in Example 1 and actual measurements.

FIG. 8 is a series of SEM images of cavity arrangement structures in Example 1.

FIG. 9 is a series of SEM images of a cavity arrangement structure in Comparative Example 1.

FIGS. 10(a) and 10(b) are a series of schematic sectional views illustrating Example 1 and Comparative Example 1.

FIG. 11 is a graph showing the transmittance spectra of Example 1 and Comparative Example 1.

FIG. 12 is a schematic view illustrating the surface modification of a cavity arrangement structure in Example 2.

FIG. 13 is a graph showing measurements obtained in Example 2.

### DETAILED DESCRIPTION OF THE PREFERRED EMBODIMENTS

A measuring method according to the present invention is a method for measuring the presence or amount of at least one analyte in a sample mixture.

As used herein, the term “sample mixture” refers to, for example, a sample containing a plurality of analytes or a sample containing at least one analyte and at least one impurity.

The phrase “measuring the presence or amount of analyte” refers to the quantification of a compound serving as an analyte present in a sample such as a liquid or a gas, encompassing the measurement of the content of trace analyte in a sample such as a solution and the identification of an analyte. The sample is preferably a liquid or a gas. The analyte is preferably a microorganism or a cell in a liquid, or an inorganic substance, an organic substance, or a hybrid thereof in a gas. Examples of inorganic substances, organic substances, and hybrids thereof in gases include PM_{2.5}, SPM, PM10, and pollen in air.

PM_{2.5} (particulate matter 2.5) is airborne particulate matter with particle sizes of roughly 2.5 μm or less. To be exact, PM_{2.5} is fine particles that pass through a particle sizer capable of collecting 50% of particles having a particle size of 2.5 μm. PM_{2.5} is thought to be associated with respiratory diseases, cardiovascular diseases, and lung cancer. SPM (suspended particulate matter) is fine particles that pass through a particle sizer capable of collecting 50% of particles having a particle size of 7 μm. PM₁₀ is fine particles that pass through a particle sizer capable of collecting 50% of particles having a particle size of 10 μm.

The measuring method according to the present invention basically includes:

a first capturing step of capturing a first analyte present as one analyte on a first cavity arrangement structure having a pair of opposing main surfaces and a plurality of cavities extending through both main surfaces;

a second capturing step of capturing an impurity, other than the analyte, present in the sample or a second analyte different from the first analyte on a second cavity arrangement structure that has a pair of opposing main surfaces and a plurality of cavities extending through both main surfaces and that differs from the first cavity arrangement structure in at least one of cavity size and surface modification; and

after the first and second capturing steps, a measuring step of irradiating the first cavity arrangement structure or the first and second cavity arrangement structures with electromagnetic radiation and detecting the characteristics of electromagnetic radiation scattered by the first cavity arrangement structure or the first and second cavity arrangement structures.

“Capturing” the first analyte in the first capturing step refers to, for example, using the first cavity arrangement structure as a filter to retain the first analyte in the cavities of the first cavity arrangement structure or to directly or indirectly deposit the first analyte on a surface of the first cavity arrangement structure modified to adsorb the first analyte. This also applies to “capturing” the impurity or the second analyte in the second capturing step.

The measuring method according to the present invention may further include, before, between, or after the first and second steps, at least one step (e.g., a third capturing step) of capturing an impurity, other than the analytes, present in the sample or another analyte different from the first and second analytes on another cavity arrangement structure that differs from the first and second cavity arrangement structures in at least one of cavity size and surface modification.

(Cavity Arrangement Structures)

The cavity arrangement structures used in the present invention have a pair of opposing main surfaces and a plurality of cavities extending through both main surfaces. For example, the cavities are periodically arranged in at least one direction in the main surfaces of the cavity arrangement structures. All cavities may be periodically arranged. Alternatively, some of the cavities may be periodically arranged, whereas other cavities may be aperiodically arranged, provided that they do not interfere with the advantages of the present invention.

Preferred cavity arrangement structures include quasi-periodic structures and periodic structures. Quasi-periodic structures are ordered structures having no translational symmetry. Examples of quasi-periodic structures include one-dimensional quasi-periodic structures such as Fibonacci structures and two-dimensional quasi-periodic structures such as Penrose structures. Periodic structures are structures having spatial symmetries such as translational symmetry and are classified into one-, two-, and three-dimensional periodic structures according to the number of dimensions of the symmetry. Examples of one-dimensional periodic structures include wire grid structures and one-dimensional diffraction gratings. Examples of two-dimensional periodic structures include mesh filters and two-dimensional diffraction gratings. Preferred periodic structures include two-dimensional periodic structures.

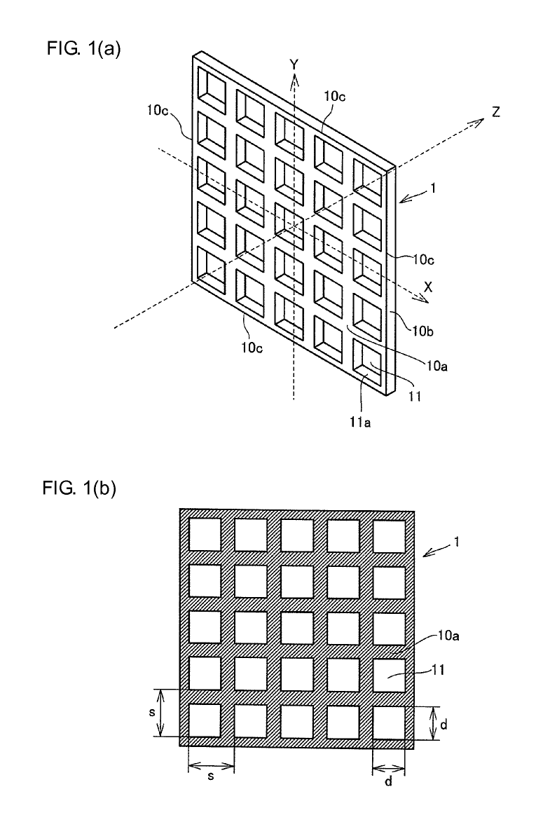

An example two-dimensional periodic structure is a plate-shaped structure (grid structure), as shown in FIGS. 1(a) and 1(b), having cavities arranged in a matrix at predetermined intervals. A cavity arrangement structure 1 shown in FIG. 1(a) is a plate-shaped structure having, as viewed from a main surface 10a thereof, square cavities 11 arranged at regular intervals in two directions parallel to the sides of the squares (i.e., in the vertical and horizontal directions in the figure).

The cavities of the first cavity arrangement structure are preferably sized to allow little or no first analyte to pass through the cavities. The cavities of the second cavity arrangement structure are preferably sized to allow little or no impurity or second analyte to pass through the cavities and to allow the first analyte to pass through the cavities.

The wavelength of the electromagnetic radiation used for measurement is preferably one tenth to ten times the opening size. This allows more intense electromagnetic radiation to be scattered and thus allows signals to be more sensitively detected.

In the cavity arrangement structure 1 shown in FIG. 1(a), in which the cavities are regularly arranged in two orthogonal directions, the grid pitch of the cavities indicated by s in FIG. 1(b) is preferably one tenth to ten times the wavelength of the electromagnetic radiation used for measurement. This allows more scattering to occur.

The thickness of the cavity arrangement structures is preferably, but not limited to, five times or less the wavelength of the electromagnetic radiation used for measurement. This allows more intense electromagnetic radiation to be scattered and thus allows signals to be more sensitively detected.

The cavity arrangement structures may have any overall size, depending on, for example, the beam spot area of the electromagnetic radiation used for irradiation.

The surfaces of the cavity arrangement structures are preferably at least partially made of a conductor. The surface of the cavity arrangement structure 1 shown in FIG. 1(a) includes main surfaces 10a, side surfaces 10b, and cavity inner surfaces 11a. The entire cavity arrangement structures may be made of a conductor.

Conductors are materials (substances) that conduct electricity and include metals and semiconductors. Examples of metals include metals capable of binding with the functional groups of compounds having functional groups such as hydroxy, thiol, and carboxy groups; metals capable of being coated with functional groups such as hydroxy and amino groups; and alloys thereof. Specific examples include gold, silver, copper, iron, nickel, chromium, silicon, and germanium, preferably gold, silver, copper, nickel, and chromium, more preferably gold and nickel. Gold and nickel are advantageous if host molecules having thiol groups (—SH groups) are used since the host molecules can be bound to the surfaces of the cavity arrangement structures with the thiol groups. Nickel is advantageous if host molecules having alkoxysilyl groups are used since the host molecules can be bound to the surfaces of the cavity arrangement structures with the alkoxysilyl groups. Examples of semiconductors include Group IV semiconductors (e.g., Si and Ge); compound semiconductors such as Group II-VI semiconductors (e.g., ZnSe, CdS, and ZnO), Group III-V semiconductors (e.g., GaAs, InP, and GaN), Group IV compound semiconductors (e.g., SiC and SiGe), and I-III-VI semiconductors (e.g., CuInSe₂); and organic semiconductors.

Embodiments of the present invention will now be described in detail, although these embodiments are not intended to limit the scope of the present invention.

### First Embodiment

In the measuring method according to this embodiment, as shown in FIG. 3(a), a cavity arrangement structure 1a (second cavity arrangement structure) having cavities with a large opening size, a cavity arrangement structure 1b (third cavity arrangement structure) having cavities with a medium opening size, and a cavity arrangement structure 1c (first cavity arrangement structure) having cavities with a small opening size are first arranged in series inside a channel.

The cavities of the cavity arrangement structure 1a (second cavity arrangement structure) are sized to allow little or no debris and dust (impurity) to pass through the cavities and to allow PM_{2.5} (first analyte) and pollen (second analyte) to pass through the cavities. Specifically, for example, if the cavities of the cavity arrangement structure 1a (second cavity arrangement structure) are regularly arranged in two orthogonal directions, as in the cavity arrangement structure 1 shown in FIG. 1(a), the opening size of the cavities indicated by d in FIG. 1(b) is preferably smaller than or equal to the size of debris and dust (impurity) (e.g., the length of the longest straight line joining two points on the surface of the impurity), most preferably similar to the size of debris and dust.

The cavities of the cavity arrangement structure 1b (third cavity arrangement structure) are sized to allow little or no pollen (second analyte) to pass through the cavities and to allow PM_{2.5} (first analyte) to pass through the cavities. Specifically, for example, if the cavities of the cavity arrangement structure 1b (third cavity arrangement structure) are regularly arranged in two orthogonal directions, as in the cavity arrangement structure 1 shown in FIG. 1(a), the opening size of the cavities indicated by d in FIG. 1(b) is preferably smaller than or equal to the size of pollen (second analyte) (e.g., the length of the longest straight line joining two points on the surface of the analyte), most preferably similar to the size of pollen.

The cavities of the cavity arrangement structure 1c (first cavity arrangement structure) are sized to allow little or no PM_{2.5} (first analyte) to pass through the cavities. Specifically, for example, if the cavities of the cavity arrangement structure 1c (first cavity arrangement structure) are regularly arranged in two orthogonal directions, as in the cavity arrangement structure 1 shown in FIG. 1(a), the opening size of the cavities indicated by d in FIG. 1(b) is preferably smaller than or equal to the size of PM_{2.5} (first analyte) (e.g., the length of the longest straight line joining two points on the surface of the analyte), most preferably similar to the size of the analyte.

A sample (air) is then allowed to flow through, in sequence, the cavity arrangement structure 1a, the cavity arrangement structure 1b, and the cavity arrangement structure 1c. As shown in FIG. 3(b), large particles such as debris and dust are first captured by the cavity arrangement structure 1a (second capturing step). Medium particles such as pollen are then captured by the cavity arrangement structure 1b (third capturing step). Other particles such as PM_{2.5} are then captured by the cavity arrangement structure 1c (first capturing step).

(Measuring Step)

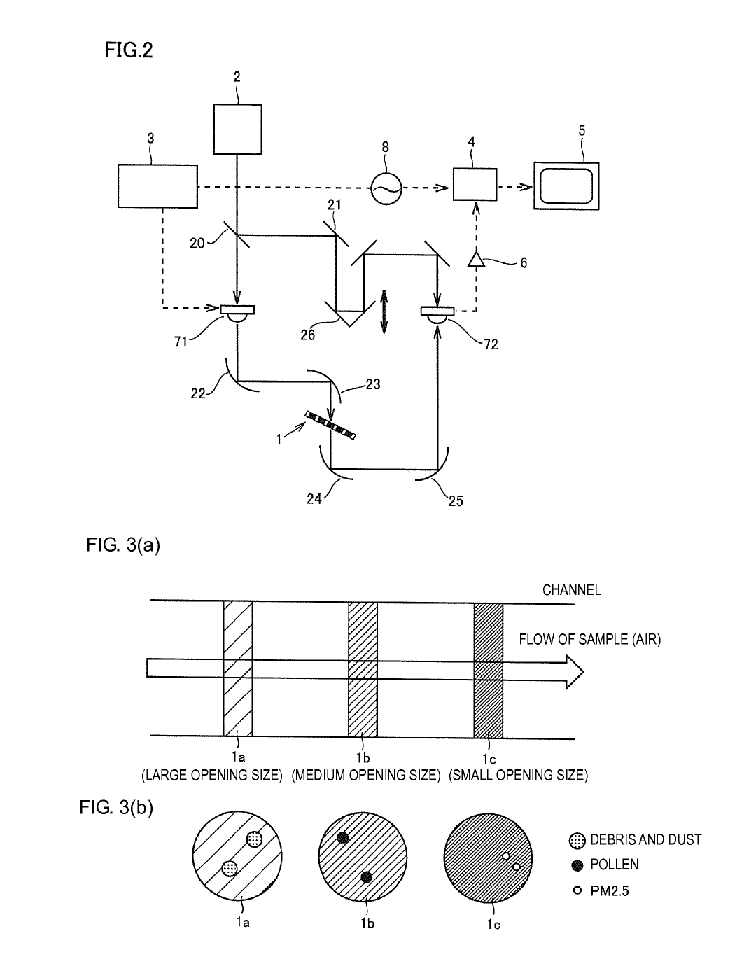

An overview of an example measuring step in the present invention will now be described with reference to FIG. 2. FIG. 2 is a schematic view of the overall configuration of an example measuring system used in the measuring step. This measuring system uses pulsed electromagnetic radiation (e.g., terahertz radiation with a frequency of 20 GHz to 120 THz) generated from a semiconductor material upon irradiation with a laser beam emitted from a laser 2 (e.g., a short-pulsed laser).

In the configuration in FIG. 2, a laser beam emitted from the laser 2 is split into two paths by a beam splitter 20. One split beam is directed to a photoconductive device 71 serving as an electromagnetic radiation generator, whereas the other split beam is directed to a photoconductive device 72 serving as an electromagnetic radiation receptor via a time delay stage 26 by a plurality of mirrors 21 (reference numerals are omitted for the mirrors having the same function). The photoconductive devices 71 and 72 may be common photoconductive devices including a dipole antenna having a gap in low-temperature-grown GaAs (LT-GaAs). The laser 2 may be, for example, a fiber laser or a solid laser such as a titanium-sapphire laser. The electromagnetic radiation may instead be generated and detected using a semiconductor surface having no antenna or an electro-optical crystal such as ZnTe crystal. A power supply 3 applies an appropriate bias voltage to the gap of the generator photoconductive device 71.

The generated electromagnetic radiation is collimated by a parabolic mirror 22 and is directed to the cavity arrangement structure 1 by a parabolic mirror 23. The terahertz radiation transmitted by the cavity arrangement structure 1 is directed to the photoconductive device 72 by parabolic mirrors 24 and 25. The electromagnetic radiation signals received by the photoconductive device 72 are amplified by an amplifier 6 and are received in the form of a time waveform by a lock-in amplifier 4. A personal computer (PC) 5 including calculating means then performs signal processing such as Fourier transform and calculates, for example, the transmittance spectrum of the cavity arrangement structure 1. To receive the signals at the lock-in amplifier 4, the bias voltage applied to the gap of the generator photoconductive device 71 by the power supply 3 is modulated with signals generated by an oscillator 8 (over the amplitude range of 5 to 30 V). Synchronous detection can thus be performed to improve the S/N ratio.

The measuring method described above is commonly known as terahertz time-domain spectroscopy (THz-TDS).

FIG. 2 illustrates an example where the form of scattering is transmission, i.e., the measurement of the transmittance of electromagnetic radiation. As used herein, the term “scattering” is a broad concept encompassing transmission, which is a form of forward scattering, and reflection, which is a form of backward scattering. The form of scattering is preferably transmission or reflection, more preferably transmission in the zeroth-order direction or reflection in the zeroth-order direction.

Generally, the spectrum of electromagnetic radiation diffracted by a diffraction grating can be represented by the following equation:

s(sin i−sin θ)=nλ (1)

where s is the grating pitch of the diffraction grating, i is the angle of incidence, θ is the angle of diffraction, and λ is the wavelength. The “zeroth-order” in the term “zeroth-order direction” means that n is 0 in equation (1). Since s and λ cannot be 0, n=0 only if sin i-sin θ=0. Thus, the term “zeroth-order direction” means that the angle of diffraction is identical to the angle of incidence, i.e., the electromagnetic radiation does not change direction.

The electromagnetic radiation used in the present invention may be any electromagnetic radiation that can be scattered depending on the cavity arrangement structure. Examples of such electromagnetic radiation include radio waves, infrared radiation, visible light, ultraviolet radiation, X-rays, and gamma rays. The frequency of the electromagnetic radiation is preferably, but not limited to, 1 GHz to 1 PHz, more preferably 20 GHz to 200 THz, i.e., terahertz radiation.

The electromagnetic radiation may be, for example, electromagnetic radiation linearly polarized in a predetermined direction (i.e., linearly polarized radiation) or unpolarized electromagnetic radiation (i.e., unpolarized radiation). Examples of linearly polarized electromagnetic radiation include terahertz radiation generated by the optical rectification of light emitted from short-pulsed lasers in electro-optical crystals such as ZnTe crystal, visible light emitted from semiconductor lasers, and electromagnetic radiation emitted from photoconductive antennas. Examples of unpolarized electromagnetic radiation include infrared light emitted from high-pressure mercury lamps and ceramic lamps.

In the measuring step, the properties of the analyte are measured based on at least one parameter associated with the frequency characteristics, determined as described above, of the electromagnetic radiation scattered by the cavity arrangement structure. For example, the properties of the analyte may be measured based on a change in the waveform of the frequency characteristics of the electromagnetic radiation scattered by the cavity arrangement structure 1 due to the presence of the analyte, e.g., a change in a dip waveform found in the frequency characteristics of forward-scattered (i.e., transmitted) electromagnetic radiation or a change in a peak waveform found in the frequency characteristics of backward-scattered (i.e., reflected) electromagnetic radiation.

As used herein, the term “dip waveform” refers to a trough (downward-protruding) waveform found in part of the frequency characteristics (e.g., the transmittance spectrum) of the cavity arrangement structure in the frequency range where the ratio of the detected electromagnetic radiation to the incident electromagnetic radiation (e.g., the transmittance of the electromagnetic radiation) is relatively high. The term “peak waveform” refers to a crest (upward-protruding) waveform found in part of the frequency characteristics (e.g., the reflectance spectrum) of the cavity arrangement structure in the frequency range where the ratio of the detected electromagnetic radiation to the incident electromagnetic radiation (e.g., the reflectance of the electromagnetic radiation) is relatively low.

The measuring step may be separate from or continuous with the first and second capturing steps. Specifically, for example, the cavity arrangement structure on which the analyte is retained in the first or second capturing step may be transferred to a separate measuring instrument before the measuring step is performed. Alternatively, the cavity arrangement structure on which the analyte is retained may be immediately irradiated with electromagnetic radiation without being transferred to perform the measuring step.

### Second Embodiment

This embodiment differs from the first embodiment in that the first cavity arrangement structure has a surface modified to adsorb the first analyte, and the second cavity arrangement structure has a surface modified to adsorb the impurity or the second analyte and to adsorb little first analyte. The same features as in the first embodiment are not described herein.

For example, the surface modified to adsorb the analyte may be a surface coated with a substance having a high affinity to the analyte. Alternatively, the surface of the cavity arrangement structure may be modified with host molecules to which the analyte binds. As used herein, the term “host molecules” refers to, for example, molecules to which the analyte can bind specifically. Examples of combinations of host molecules and analytes include antigens with antibodies, sugar chains with proteins, lipids with proteins, low-molecular-weight compounds (ligands) with proteins, proteins with proteins, and single-stranded DNA with single-stranded DNA.

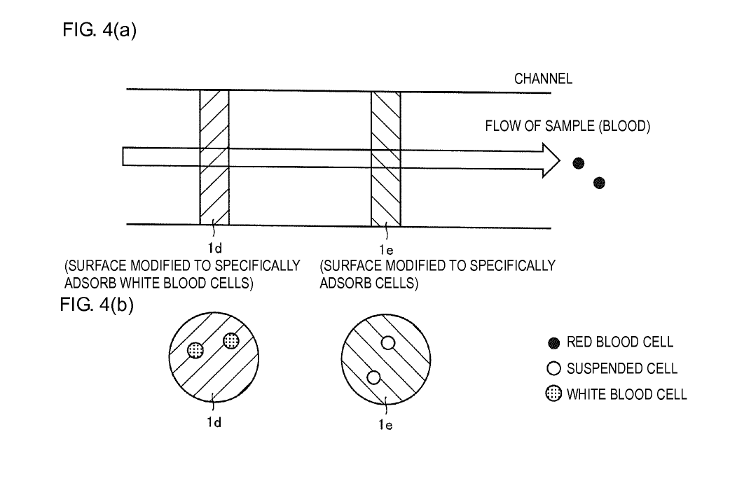

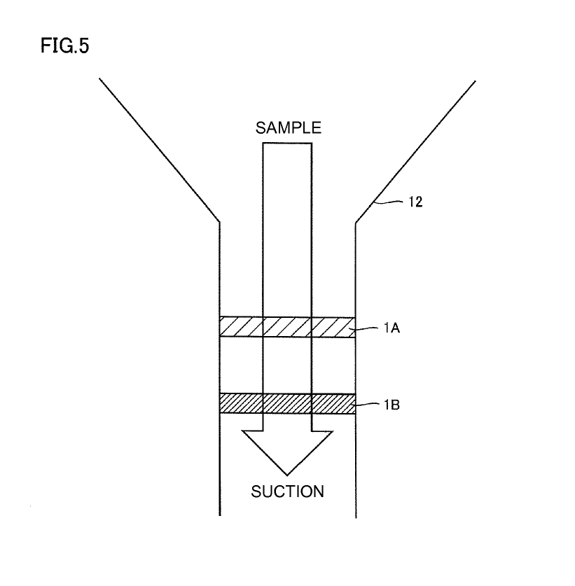

Specifically, as shown in FIG. 4(a), a cavity arrangement structure 1d (second cavity arrangement structure) having a surface modified to specifically adsorb white blood cells (impurity) and a cavity arrangement structure 1e (first cavity arrangement structure) having a surface modified to specifically adsorb suspended cells (first analyte) are first arranged in series inside a channel.

For example, the cavities of the cavity arrangement structure 1d (second cavity arrangement structure) are sized to allow components having sizes smaller than or equal to the size of suspended cells to pass through the cavities, and the cavities of the cavity arrangement structure 1e (first cavity arrangement structure) are sized to allow components having sizes smaller than or equal to the size of red blood cells to pass through the cavities.

A sample (blood) is then allowed to flow through the cavity arrangement structure 1d and then through the cavity arrangement structure 1e. As shown in FIG. 4(b), white blood cells are first captured by the cavity arrangement structure 1d (second capturing step). Suspended cells are then captured by the cavity arrangement structure 1e (first capturing step). The sample containing red blood cells (blood from which white blood cells and suspended cells have been removed) is drained downstream.

The measuring method according to this embodiment can be applied, for example, to blood tests. A plurality of cavity arrangement structures having modified surfaces and cavities of controlled opening size can be used to detect suspended cells such as cancer cells in blood while removing impurities such as white blood cells and red blood cells.

### EXAMPLES

The present invention is further illustrated by the following examples, although these examples are not intended to limit the scope of the present invention.

### Example 1

As shown in FIG. 5, a jig 12 having an upward-converging tapered opening was first equipped with a cavity arrangement structure 1A (second cavity arrangement structure) and a cavity arrangement structure 1B (first cavity arrangement structure). The jig 12 equipped with the cavity arrangement structures 1A and 1B was installed outdoors. A sample (air) was passed through the cavity arrangement structures 1A and 1B (downward in FIG. 5) by suction using a diaphragm pump (suction rate: 11 L/min) for 10 minutes to capture impurities other than PM_{2.5} on the cavity arrangement structure 1A and PM_{2.5} (first analyte) on the cavity arrangement structure 1B.

The cavity arrangement structures 1A and 1B were nickel plate-shaped structures, as shown in FIGS. 1(a) and 1(b), having square cavities arranged in a square grid pattern in a direction parallel to the main surfaces thereof and having a thickness of 1 to 2 μm. The entire plate-shaped structures were disc-shaped and had an outer diameter of 6 mm. The cavity arrangement structure 1A had a pitch (s in FIG. 1(b)) of 7.1 μm and an opening size (d in FIG. 1(b)) of 4.2 μm. The cavity arrangement structure 1B had a pitch of 2.6 μm and an opening size of 1.8 μm.

The cavity arrangement structure 1B on which PM_{2.5} was deposited was detached from the jig 12 and was irradiated with electromagnetic radiation to measure the transmittance spectrum. The change (Δf) in the peak frequency of the dip waveform relative to that of the cavity arrangement structure 1B before suction (i.e., on which no substance was deposited) was determined.

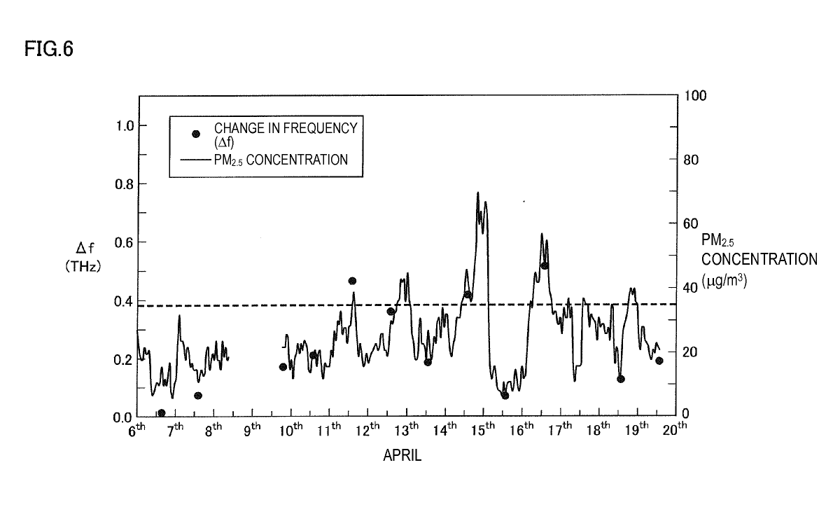

In this way, the change in peak frequency was determined once per day from Apr. 6 to 19, 2013. The results are summarized in FIG. 6 along with PM_{2.5} concentration measurements available from the Ministry of the Environment. These measurements were taken by a weight concentration measuring method (filter sampling) at an official measurement site about 2 km away from the site where measurements were performed using the cavity arrangement structures (the change in peak frequency on 17th was not measurable since the dip waveform in the transmittance spectrum disappeared, and the PM_{2.5} concentrations on 8th and 9th are not shown since no data was available due to the maintenance of the measuring system of the Ministry of the Environment from 10 a.m. on 8th to 5 p.m. on 9th). As shown in FIG. 6, the change (Δf) in peak frequency determined in this example varied in the same manner as the PM_{2.5} concentration measurements available from the Ministry of the Environment.

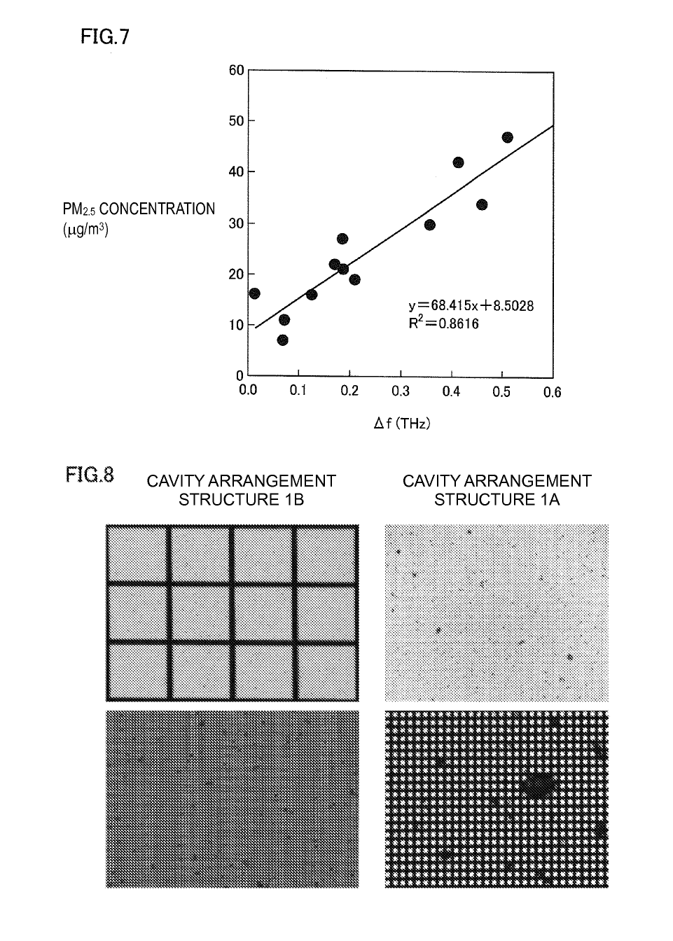

FIG. 7 shows a regression curve derived from the change (Δf) in peak frequency determined in this example and the PM_{2.5} concentration measurements available from the Ministry of the Environment in FIG. 6. The coefficient of determination R² (i.e., the square of the correlation coefficient) is 0.8616, indicating that there is a correlation between the change in peak frequency determined in this example and the PM_{2.5} concentration measurements available from the Ministry of the Environment.

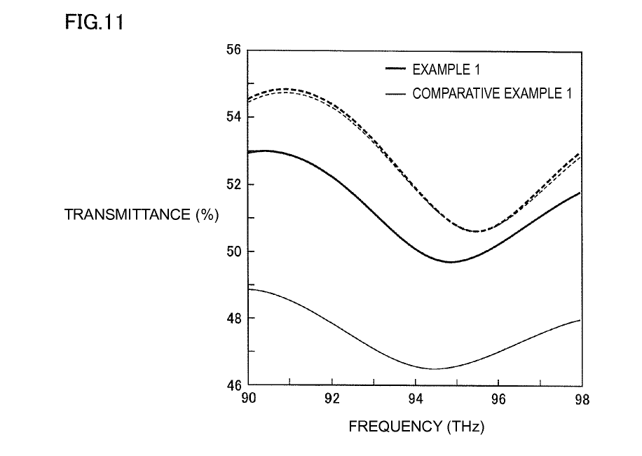

FIG. 8 shows scanning electron microscopy (SEM) images of the cavity arrangement structure 1A (right column) and the cavity arrangement structure 1B (left column) after suction filtration in Example 1. The upper images are enlarged images of the lower images. In this example, as shown in FIG. 10(a), the sample (air) was filtered through the two cavity arrangement structures 1A and 1B of different cavity sizes (opening sizes). The results showed that large particles, which are impurities, were captured by the cavity arrangement structure 1B, and only small particles were deposited on the cavity arrangement structure 1A, on which no large particles were deposited.

### Comparative Example 1

A sample (air) was passed through the cavity arrangement structure 1B by suction around 2 p.m. on Apr. 16, 2013 as in Example 1 except that the jig 12 was not equipped with the cavity arrangement structure 1A but only with the cavity arrangement structure 1B. The transmittance spectrum of the cavity arrangement structure 1B was measured, and the change in the peak frequency of the dip waveform relative to that of the cavity arrangement structure 1B on which no substance was deposited was determined.

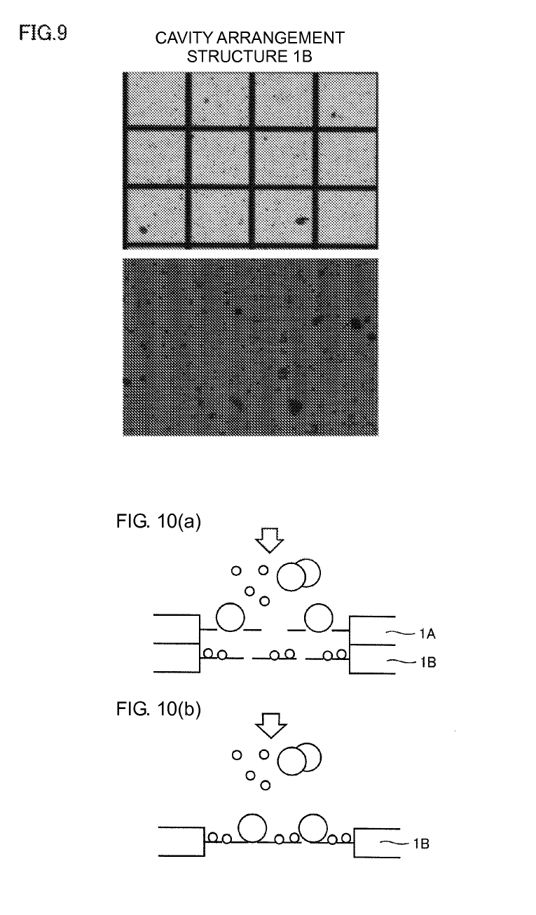

FIG. 9 shows SEM images of the cavity arrangement structure 1B after suction filtration in Comparative Example 1. The upper image is an enlarged image of the lower image. In Comparative Example 1, as shown in FIG. 10(b), the sample (air) was filtered only through the cavity arrangement structure 1B. The results showed that large particles, which are impurities, were also captured by the cavity arrangement structure 1B. This leads to increased measurement noise.

FIG. 11 shows the transmittance spectrum of the cavity arrangement structure 1B in Comparative Example 1. In this graph, the transmittance spectrum before suction is indicated by the dotted line (thin line), and the transmittance spectrum after suction is indicated by the solid line (thin line). FIG. 11 also shows the transmittance spectrum of the cavity arrangement structure 1B in Example 1 on the same day as in Comparative Example 1 (i.e., around 2 p.m. on Apr. 16, 2013). In this graph, the transmittance spectrum before suction is indicated by the dotted line (thick line), and the transmittance spectrum after suction is indicated by the solid line (thick line).

The change (Δf) in the peak frequency of the dip waveform in the transmittance spectrum after suction in Example 1 was determined to be 0.55 THz from the results in FIG. 11. The change (Δf) in the peak frequency of the dip waveform in the transmittance spectrum after suction in Comparative Example 1 was determined to be 1.01 THz. That is, the Δf of Example 1 was nearly half that of Comparative Example 1.

According to the measurements available from the Ministry of the Environment that were taken at the place where Example 1 and Comparative Example 1 were conducted at 2 p.m. on Apr. 16, 2013, the PM_{2.5} concentration was 47 μg/m³, and the SPM concentration was 46 μg/m³ (total: 93 μg/m³). That is, the ratio of the PM_{2.5} concentration to the SPM concentration in air on that day was about 1:1. These results suggest that, whereas both SPM and PM_{2.5} were captured by the cavity arrangement structure 1B in Comparative Example 1, only PM_{2.5} was captured by the cavity arrangement structure 1B in Example 1 since particles such as SPM were captured by the cavity arrangement structure 1A. This allows only PM_{2.5} to be detected.

The weight concentration measuring method employed by the Ministry of the Environment involves measuring the weight of collected analyte using a digital scale. This method is disadvantageous in that it requires a large amount of sample (i.e., a long collection time). The measuring method according to this embodiment, which uses cavity arrangement structures, is advantageous in that it has high measurement sensitivity and thus requires a small amount of sample (i.e., a short collection time).

### Example 2

### Preparation of Cavity Arrangement Structure 1B

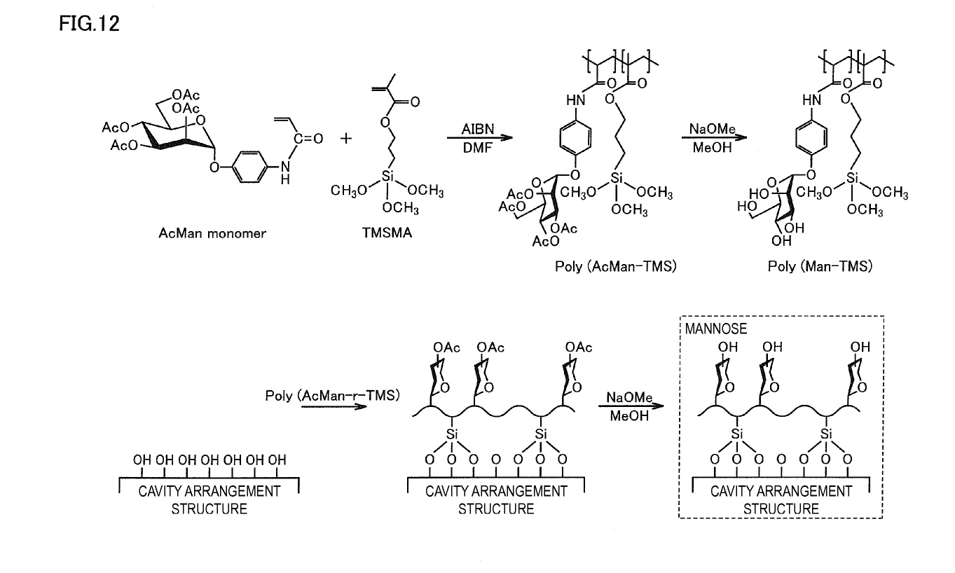

A nickel plate-shaped structure, as shown in FIGS. 1(a) and 1(b), having square cavities arranged in a square grid pattern in a direction parallel to the main surfaces thereof was provided as the cavity arrangement structure 1B. The entire plate-shaped structure was disc-shaped and had an outer diameter of 6 mm. The cavity arrangement structure had a thickness of 1.0 μm, a cavity pitch of 2.6 μm, and an opening size of 1.8 μm. As shown in FIG. 12, the surface of the cavity arrangement structure was modified with a silane-coupling-agent-introduced sugar chain polymer (poly(AcMan-TMS)) to immobilize mannose as host molecules. The transmission characteristics (transmittance spectrum) of the cavity arrangement structure after mannose immobilization (i.e., on which no substance was deposited) were measured as the initial characteristics by FTIR.

An E. coli strain, termed ORN178, having a sugar chain (mannose) recognition receptor (protein) and an E. coli strain, termed ORN208, having no sugar chain recognition receptor were provided. Each E. coli strain was used to prepare a suspension with a concentration of 10⁹ [cells/mL]. The cavity arrangement structure after mannose immobilization (i.e., after the measurement of transmission characteristics) was immersed in the suspension to perform incubation at 37° C. for 10 minutes. After incubation, the cavity arrangement structure was sufficiently rinsed with water and was dried. The transmission characteristics of the dried cavity arrangement structure were measured by FTIR. The change (Δf) in the peak frequency of the dip waveform relative to that of the cavity arrangement structure before immersion in the E. coli suspension was determined. The results showed that the change (ΔF) in the peak frequency of the dip waveform of the cavity arrangement structure immersed in the ORN178 suspension was about 3 THz, whereas the change (ΔF) in the peak frequency of the dip waveform of the cavity arrangement structure immersed in the ORN208 suspension was substantially zero.

[Measurement]

As shown in FIG. 5, a jig 12 having an upward-converging tapered opening was first equipped with a cavity arrangement structure 1A (second cavity arrangement structure) and the above cavity arrangement structure 1B (first cavity arrangement structure).

The cavity arrangement structure 1A was a nickel cavity arrangement structure as shown in FIGS. 1(a) and 1(b) and had a pitch of 7.8 μm, an opening size of 5.4 μm, and a thickness of 2.0 μm. The entire cavity arrangement structure was disc-shaped and had an outer diameter of 6 mm.

Six ORN178 suspensions having different concentrations within the range of 10⁵ to 10⁹ [cells/mL] and six ORN208 suspensions having the same concentrations were then prepared. Latex particles having a particle size of 10 μm were added to the above suspensions as a model impurity in a concentration of 100 [μg/mL].

The sample suspensions, i.e., the ORN178 and ORN208 suspensions containing the latex particles as an impurity, were passed through the cavity arrangement structure 1A

and then through the cavity arrangement structure 1B by suction using the above jig (in the direction indicated by the arrow in FIG. 5). The cavity arrangement structures 1A and 1B were detached from the jig, and the surfaces of the cavity arrangement structures were examined under a stereoscopic microscope. The examination results showed that the latex particles were present only on the cavity arrangement structure 1A and not on the cavity arrangement structure 1B.

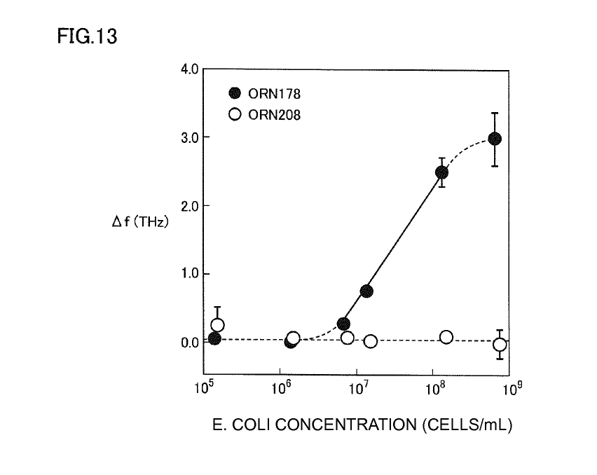

The cavity arrangement structure 1B after suction was sufficiently rinsed with water and was dried. The transmission characteristics of the dried cavity arrangement structure 1B were measured by FTIR and were compared with the initial characteristics. FIG. 13 shows the change (Δf) in the peak frequency of the dip waveform after immersion in the suspensions having different concentrations. The results showed that only ORN178, which has a sugar chain recognition receptor, adsorbed specifically on the cavity arrangement structure 1B and thus changed the transmission characteristics of the cavity arrangement structure 1B.

The measuring method according to the present invention allows a smaller amount of analyte to be measured by a simpler process than those in the related art. For example, if the analyte is a microorganism, such as E. coli, present in trace amounts in a liquid sample, the microorganism can be concentrated by filtration and immediately measured, for example, without cultivation.

Although a surface-modified cavity arrangement structure is used to detect a particular E. coli strain in this example, it can also be used in other applications. For example, the measuring method according to the present invention can be applied to blood tests. A plurality of cavity arrangement structures having cavities of controlled size and modified surfaces can be used to detect cancer cells in blood (i.e., circulating tumor cells (CTCs)) while removing impurities such as white blood cells and red blood cells.

The embodiments and examples disclosed herein are to be considered in all respects as illustrative and not restrictive. The scope of the present invention is indicated by the appended claims, rather than by the foregoing description, and all changes that come within the meaning and range of equivalency of the claims are intended to be embraced therein.

### REFERENCE SIGNS LIST

1, 1a, 1b, 1c, 1d, 1e, 1A, 1B cavity arrangement structure
10a main surface
10b side surface
11 cavity
11a inner surface
12 jig
2 laser
20 beam splitter
21 mirror
22, 23, 24, 25 parabolic mirror
26 time delay stage
3 power supply
4 lock-in amplifier
5 personal computer (PC)
6 amplifier
71, 72 photoconductive device
8 oscillator

1. A method for measuring the presence or amount of at least one analyte in a sample mixture, the method comprising:
capturing a first analyte from the sample mixture on a first cavity arrangement structure having a pair of opposing main surfaces and a plurality of cavities extending through the pair of opposing main surfaces;
capturing an impurity, other than the first analyte, present in the sample mixture or a second analyte different from the first analyte on a second cavity arrangement structure having a pair of opposing main surfaces and a plurality of cavities extending through the pair of opposing main surfaces, the second cavity arrangement structure differing from the first cavity arrangement structure in at least one of cavity size and surface modification; and
after capturing the first analyte and the impurity, irradiating the first cavity arrangement structure or the first and second cavity arrangement structures with electromagnetic radiation and detecting characteristics of electromagnetic radiation scattered by the first cavity arrangement structure or the first and second cavity arrangement structures.

2. The measuring method according to claim 1, wherein the plurality of cavities of the first cavity arrangement structure are sized to allow none of the first analyte to pass therethrough.

3. The measuring method according to claim 2, wherein the first cavity arrangement structure has a surface modified to adsorb the first analyte.

4. The measuring method according to claim 1, wherein the first cavity arrangement structure has a surface modified to adsorb the first analyte.

5. The measuring method according to claim 1, wherein the capturing of the first analyte is performed after the capturing of the impurity or the second analyte.

6. The measuring method according to claim 2, wherein the plurality of cavities of the second cavity arrangement structure are sized to allow none of the impurity or second analyte to pass therethrough and to allow the first analyte to pass therethrough.

7. The measuring method according to claim 6, wherein the second cavity arrangement structure has a surface modified to adsorb the impurity or the second analyte.

8. The measuring method according to claim 1, wherein the plurality of cavities of the second cavity arrangement structure are sized to allow none of the impurity or second analyte to pass therethrough and to allow the first analyte to pass therethrough.

9. The measuring method according to claim 8, wherein the second cavity arrangement structure has a surface modified to adsorb the impurity or the second analyte.

10. The measuring method according to claim 3, wherein the plurality of cavities of the second cavity arrangement structure are sized to allow none of the impurity or second analyte to pass therethrough and to allow the first analyte to pass therethrough.

11. The measuring method according to claim 10, wherein the second cavity arrangement structure has a surface modified to adsorb the impurity or the second analyte.

12. The measuring method according to claim 5, wherein the first and second cavity arrangement structures are arranged in series and the sample mixture is allowed to flow through the second cavity arrangement structure and then through the first cavity arrangement structure.

13. The measuring method according to claim 1, wherein the sample mixture is a liquid or a gas.

14. The measuring method according to claim 13, wherein the first analyte is a microorganism or a cell in a liquid, or an inorganic substance, an organic substance, or a hybrid thereof in a gas.
